(19) United States
(12) Patent Application Publication
(10) Pub. No.: US 2018/0108048 A1
(43) Pub. Date: Apr. 19, 2018

(54) METHOD, APPARATUS AND SYSTEM FOR RECOMMENDING CONTENTS

(71) Applicant: SAMSUNG SDS CO., LTD., Seoul (KR)

(72) Inventors: Seung Hyun YOON, Seoul (KR); A Na LEE, Seoul (KR)

(73) Assignee: SAMSUNG SDS CO., LTD., Seoul (KR)

(21) Appl. No.: 15/709,978

(22) Filed: Sep. 20, 2017

(30) Foreign Application Priority Data
Oct. 19, 2016 (KR) 10-2016-0135549

(51) Int. Cl. G06Q 30/02; G06Q 30/06; G06K 9/62

(52) U.S. Cl. CPC G06Q 30/0271; G06K 9/6223; G06Q 30/0631

(57) ABSTRACT

A method for recommending contents executed by a contents recommendation server is provided. The method includes: determining first recommendation contents based on first type information of a first user acquired at a first time point and a contents recommendation model; transmitting the first recommendation contents to a contents recommendation terminal and receiving feedback information of the first user exposed to the first recommendation contents from the contents recommendation terminal; updating the contents recommendation model by applying the feedback information to the contents recommendation model; determining second recommendation contents based on second type information of a second user acquired at a second time point and the updated contents recommendation model, the second time point being after the first time point; and transmitting the second recommendation contents to the contents recommendation terminal.

### CROSS-REFERENCE TO RELATED APPLICATION

This application claims priority from Korean Patent Application No. 10-2016-0135549 filed on Oct. 19, 2016 in the Korean Intellectual Property Office, the disclosure of which is incorporated herein by reference in its entirety.

### BACKGROUND

### 1. Field

Apparatuses and methods consistent with exemplary embodiments relate to recommending customized contents in consideration of type information of a user.

### 2. Description of the Related Art

In the method for providing passive contents performed by the conventional retrieval, there have been many problems in efficiently and accurately securing information required by the user. As an alternative plan thereof, a method for recommending contents is currently utilized by taking the user's types into account in various fields.

For example, many business operators recommend a specific brand for each user's type by utilizing digital signage installed in a complex shopping mall, and use the specific brand as a kind of target marketing strategy.

The current contents recommendation method mostly operates based on rules. More specifically, the contents recommendation method operates in such a manner that an administrator defines rules as illustrated in FIG. 1 on the basis of prior knowledge provided by the marketer, and recommends contents such as a specific brand in accordance with the defined rule. For example, when the user is a teenage male, a brand A and a brand B are recommended in accordance with a first rule, and when the user is a woman in her twenties, a brand C is recommended in accordance with a fourth rule.

However, since the aforementioned rule-based contents recommendation method is difficult to reflect the user's preference that varies with time, there is a problem that the accuracy of recommendation inevitably drops. Even if a rule is changed or redefined to reflect the user's preference, since the time and cost are continuously consumed, this case is inefficient in terms of maintenance.

Further, since the rule passively defined by the administrator mostly distinguishes the user's type only on the basis of static information such as users' age and gender, because of limit of the prior knowledge, the rule has certain limits in recommending the user customized content. That is, since it is not possible to subdivide the user's type in consideration of the dynamic information such as the user's current context, it is not possible to perform the recommendations reflecting the user's needs that may vary depending on the situation.

Therefore, there is a need for a contents recommendation method that subdivides the user's type in consideration of the user's situation information to improve the accuracy of recommendation and can reflect the user's preference that changes depending on the time.

### SUMMARY

One or more exemplary embodiments provide a method, an apparatus, and a system for recommending customized contents in accordance with a user's type.

Further, one or more exemplary embodiments provide a method, an apparatus, and a system for recommending customized contents to the user, in consideration of information on various situations such as time, weather, and group type, in addition to demographic information of a user such as age and gender.

Further still, one or more exemplary embodiments provide a method, an apparatus, and a system for recommending customized contents by reflecting user's preference that may change with time.

According to an aspect of an exemplary embodiment, there is provided a method for recommending contents executed by a contents recommendation server. The method comprises determining first recommendation contents based on first type information of a first user acquired at a first time point and a contents recommendation model, transmitting the first recommendation contents to a contents recommendation terminal and receiving feedback information of the first user exposed to the first recommendation contents from the contents recommendation terminal, updating the contents recommendation model by applying the feedback information to the contents recommendation model, determining second recommendation contents based on second type information of a second user acquired at a second time point and the updated contents recommendation model, the second time point being after the first time point and transmitting the second recommendation contents to the contents recommendation terminal, wherein the first type information comprises situation information at the first time point, and the second type information comprises situation information at the second time point, the first type information and the second type information indicate a same type information, and the second recommendation contents are different from the first recommendation contents.

According to an aspect of another exemplary embodiment, there is provided a method for recommending contents executed by a contents recommendation server. The method comprises acquiring type information of a user comprising a situation information of the user, determining a recommendation policy of a plurality of recommendation policies based on an occupancy ratio of a first recommendation policy to the plurality of recommendation policies, the plurality of recommendation policies comprising the first recommendation policy and a second recommendation policy and determining recommendation contents based on the determined recommendation policy, wherein the first recommendation policy is a policy for determining the recommended contents based on a predetermined rule, and the second recommendation policy is a policy for determining the recommended contents based on a multi-armed bandits algorithm (MAB) model.

According to an aspect of another exemplary embodiment, there is provided a method for recommending contents executed by a contents recommendation server. The method comprises collecting feedback information associated with each user type through random recommendation up to a predetermined first time point, generating a rule for determining recommended contents for each user type based on the collected feedback information and determining the recommendation content after the predetermined first time point, based on at least one policy of a first recommendation policy and a second recommendation policy, the first recommendation policy being a policy for determining the recommended contents based on a predetermined rule, and the second recommendation policy being a policy for determining the recommendation contents based a multi-armed bandits algorithm (MAB) model, wherein an occupancy ratio of a second recommendation policy to a plurality of policies comprising the first recommendation policy and the second recommendation policy at the first time point is less than an occupancy ratio of the second recommendation policy to the plurality of policies at a second time point after the first time point, and a sum of an occupancy ratio of the first recommendation policy to the plurality of policies and the occupancy ratio of the second recommendation policy is constant.

According to an exemplary embodiment, accuracy of contents recommendation can be improved by subdividing the user's type in consideration of the situation information, in addition to the demographic information of the user.

In addition, there is an effect of improving the sales of the complex shopping mall, by being utilized for a target marketing strategy such as recommending a specific brand in accordance with the user's type through digital signage installed in complex shopping malls and the like.

Further, by reflecting the feedback from users of contents recommendation, using MAB (Multi-Armed Bandits) algorithm in the field of reinforcement learning, it is possible to reflect the user's preference which may vary in real time, and the accuracy of the recommendation can be further improved, accordingly.

In addition, by automatically reflecting the user's preference, using the MAB algorithm in the field of reinforcement learning, the maintenance cost can be reduced compared with the rule-based recommendation method.

Also, by collecting feedback information from users through random recommendation and automatically generating rules accordingly, it is possible to reduce the time and human cost required for investigating the user's preferences and defining them by rule.

### BRIEF DESCRIPTION OF THE DRAWINGS

The above and/or other aspects will be more apparent by describing certain exemplary embodiments, with reference to the accompanying drawings, in which:

FIG. 1 is an exemplary view of a rule used in a conventional rule-based recommendation method;

FIG. 2 is a configuration diagram of a contents recommendation system according to an exemplary embodiment;

FIG. 3 is a flowchart of the operation executed between the respective constituent elements of the contents recommendation system illustrated in FIG. 2;

FIG. 4 is a functional block diagram of a contents recommendation terminal which is a constituent element of the contents recommendation system illustrated in FIG. 2;

FIG. 5 is a hardware configuration diagram of a contents recommendation server according to another exemplary embodiment;

FIG. 6 is a functional block diagram of a contents recommendation server according to another exemplary embodiment;

FIG. 7 is a flowchart of a contents recommendation method according to another exemplary embodiment;

FIG. 8 is a detailed flowchart of a step of determining first recommendation contents illustrated in FIG. 7;

FIGS. 9A, 9B, and 9C are exemplary views of a method for extracting feature vectors;

FIG. 10 is an exemplary view of recommendation candidate data used in some exemplary embodiments;

FIG. 11 is a detailed flowchart of a step of reflecting the feedback of the first user illustrated in FIG. 7;

FIGS. 12A, 12B, 12C, and 12D are exemplary views of a method for converting the feedback information of the user into differentiated reward values and reflecting the same; and

FIGS. 13A, 13B, and 14 are diagrams for explaining an example of utilizing a plurality of recommendation policies.

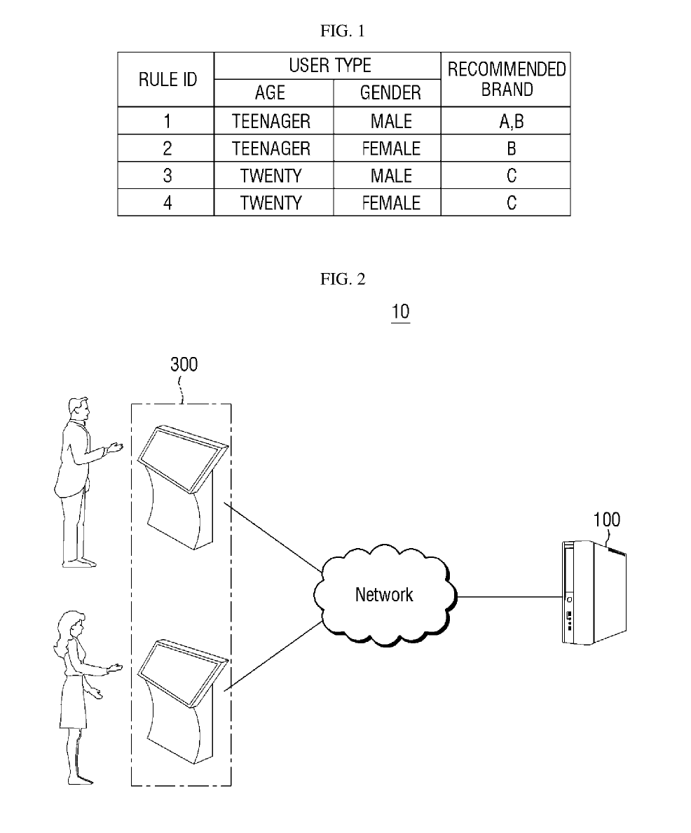

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Expressions such as “at least one of,” when preceding a list of elements, modify the entire list of elements and do not modify the individual elements of the list.

FIG. 2 is a configuration diagram of a contents recommendation system 10 according to an exemplary embodiment.

Referring to FIG. 2, the contents recommendation system 10 is a system which classifies the user's type on the basis of the user's demographic information and user's situation information, and recommends customized contents for each of the divided user's types. For example, the contents recommendation system 10 may be a system which recommends the brand of the shop located at a compound shopping mall to the user on the basis of the digital signage in the compound shopping mall.

Demographic information includes information such as the user's age, gender, nationality and the like, and the situation information means any information that may express and characterize the current status of the user. For example, the situation information may include weather, time, day of the week, position, facial expression, posture and the like, and may also include features of the group including users who have requested contents recommendation, such as a couple, family, and friends. In addition, the contents may include various kinds of information that can be displayed on the display of a contents recommendation terminal 300, as an object to be recommended. For example, the above-mentioned contents may include brand information, music information, product information, and the like.

The contents recommendation system 10 may include the contents recommendation server 100 and the contents recommendation terminal 300, and the contents recommendation server and the contents recommendation terminal may be connected to each other via a network. Although not illustrated in FIG. 2, the contents recommendation system 10 may include another data collection device and data analysis device to obtain information such as the number of a floating population of the location at which the contents recommendation system is installed, whether the user visits the shop or whether a user who visits the shop purchases the goods.

The data collection device may include an AP (Access Point) for collecting WIFI data, a video pickup device for collecting video data, and the like, and the data analyzer may include a video analytics module for deriving the above-described information from the collected video via video analytics.

Looking over each constituent element, the contents recommendation terminal 300 is a computing device that displays contents recommended by the contents recommendation server 100 to acquire feedback of the user. The computing device may be provided as a device having a feature in which an interaction with the user is easy, like a digital signage such as a kiosk. However, the present exemplary embodiment is not limited thereto, and may include all devices having computing and displaying functions, such as a laptop computer, a desktop, a laptop, and a smartphone.

The contents recommendation server 100 is a device that receives user's type information from the contents recommendation terminal 300 and determines the customized content on the basis thereof. Depending on the scale of the system, the contents recommendation server may receive the contents recommendation request from a plurality of contents recommendation terminals 300. Further, the contents recommendation server 100 may reflect the user's feedback obtained by the contents recommendation terminal 300 to perform the contents recommendation reflecting the user's preference. That is, the contents recommendation server may perform the recommendation that is more accurate than the conventional rule-based fixed recommendation method, by reflecting the user's preference that varies with time, based on feedback of the multiple users.

For reference, the contents recommendation server 100 may further subdivide the user's type, by further adding other situation information to type information of the user received from the contents recommendation terminal 300. For example, since the situation information such as weather and time is situation information which can be independently acquired by the contents recommendation server, by acquiring weather information and time information at the time of receiving the recommendation request from an internal or external data source and by adding them to type information of the user, the user's type can be subdivided.

On the other hand, in the case of the contents recommendation system 10 illustrated in FIG. 2, although the contents recommendation server 100 and the contents recommendation terminal 300 are illustrated as separate physical devices, the contents recommendation server and the contents recommendation terminal may also be provided in the form of different logics in the same physical device. In such a case, the contents recommendation server and the contents recommendation terminal may be provided in the form of communicating with each other using IPC (Inter-Process Communication) without using a network, but this is only a difference in implementation type.

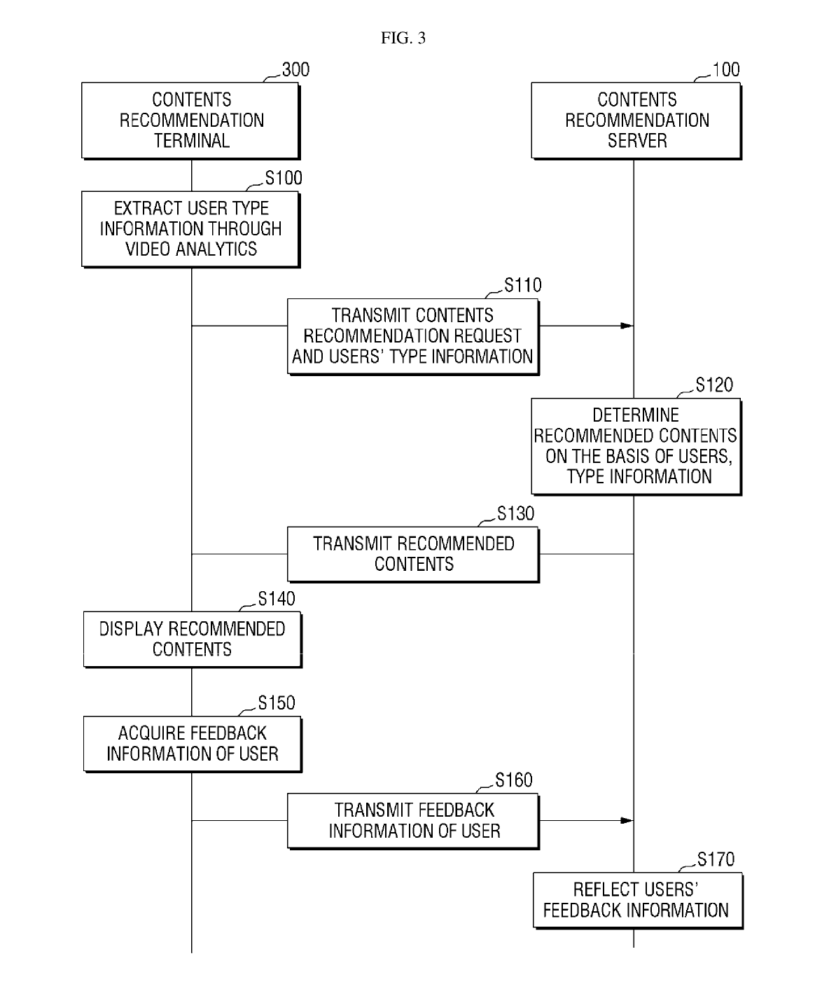

Next, with reference to FIG. 3, a brief description will be given of the flow of operations executed between the contents recommendation server 100 and the contents recommendation terminal 300, which are the respective constituent elements of the contents recommendation system 10.

First, in accordance with the user's contents recommendation request, the contents recommendation terminal 300 acquires and analyzes the user's image to extract the type information of the user (S100). The contents recommendation terminal 300 may use a built-in camera to acquire the video of the user, or may acquire the video of the user who requests the recommendation of the contents from another data collection device. Further, the contents recommendation terminal 300 may perform the video analytics, using a computer vision algorithm to extract the type information of the user. However, depending on the implementation method, the step S100 of extracting the user's type information may be performed by the contents recommendation server 100. In such a case, the contents recommendation terminal 300 may transmit the captured video to the contents recommendation server 100, and analyze the video received by the contents recommendation server to extract the user's type information.

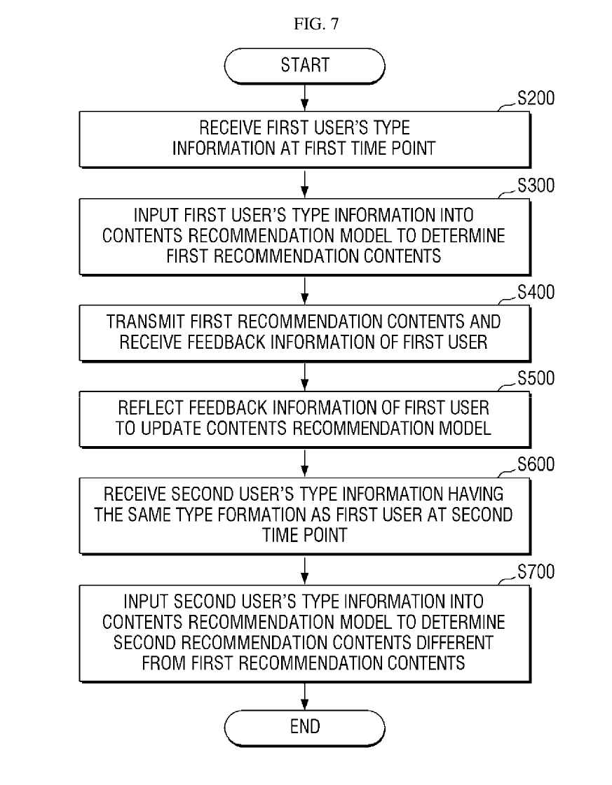

Next, the contents recommendation terminal 300 transmits the contents recommendation request message via the network, and transmits type information of the user derived through the video analytics to the contents recommendation server 100 (S110). Upon receiving the contents recommendation request message, the contents recommendation server 100 determines the recommended contents on the basis of the contents recommendation model that operates on the basis of MAB (Multi-Armed Bandit algorithm) (S120). The details of the step (S120) of determining the recommended contents will be described later with reference to FIGS. 7 to 10.

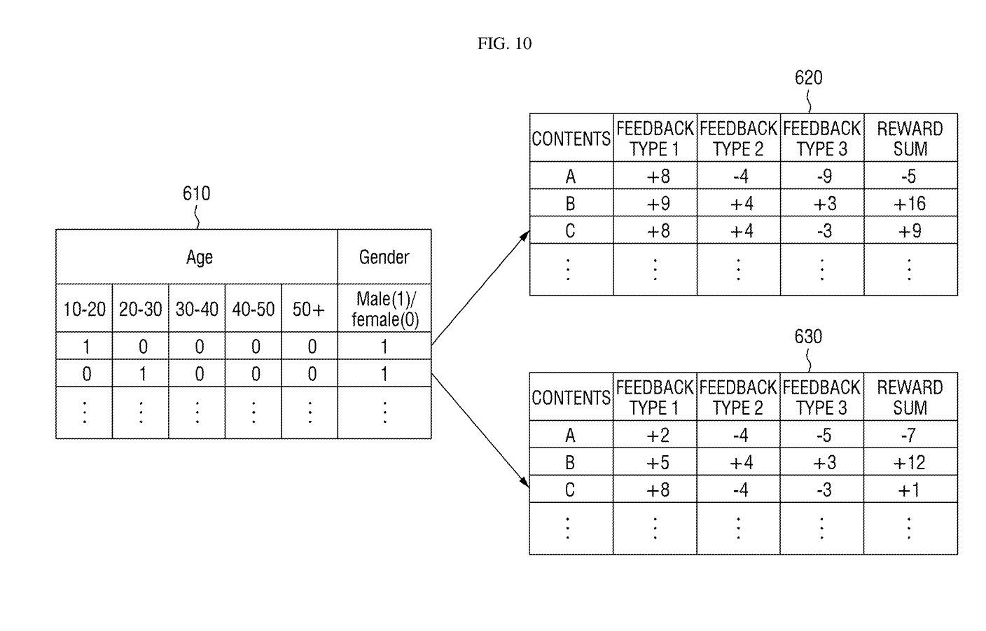

For reference, the contents recommendation model is a mode which learns a reward value indicating the preference of each content for each user's type on the basis of feedback of the user, and outputs the recommended contents of the first user's type through the MAB algorithm based on the reward value corresponding to the first user's type when the first user's type is input. Also, when the second user's type is input, the contents recommendation model may output the recommended contents to the second user's type through the MAB algorithm on the basis of the reward value corresponding to the second user's type. The reward value of the contents for each user's type learned by the contents recommendation model will be additionally described later with reference to FIG. 10.

Next, the contents recommendation server 100 transmits the recommended contents determined using the contents recommendation model to the contents recommendation terminal 300 that requested the recommendation (S130). Upon receiving the recommended content, the contents recommendation terminal 300 displays the recommended contents via the display screen (S140). For example, when recommending a brand of a shop that entered a complex shopping mall, the contents recommendation terminal 300 may display one or more recommended brands on the display screen of the kiosk for user convenience.

Next, the contents recommendation terminal 300 acquires user's feedback information according to the contents recommendation (S150). The feedback information may include various reactions of the user to the recommended contents, which may be variously defined in accordance with the type of the recommended content, the hardware characteristics of the contents recommendation terminal 300, and the like. For example, when recommending a brand of a shop that has entered a compound shopping mall via a kiosk, the user's feedback information may be a duration time at which the user gazes at the screen on which the brand is displayed, the selective input of the brand displayed on the display screen, a path finding request of the brand shop and the like. Therefore, the contents recommendation terminal may be desirable to use a device that is easy to interact with the user to facilitate acquisition of feedback information of a user.

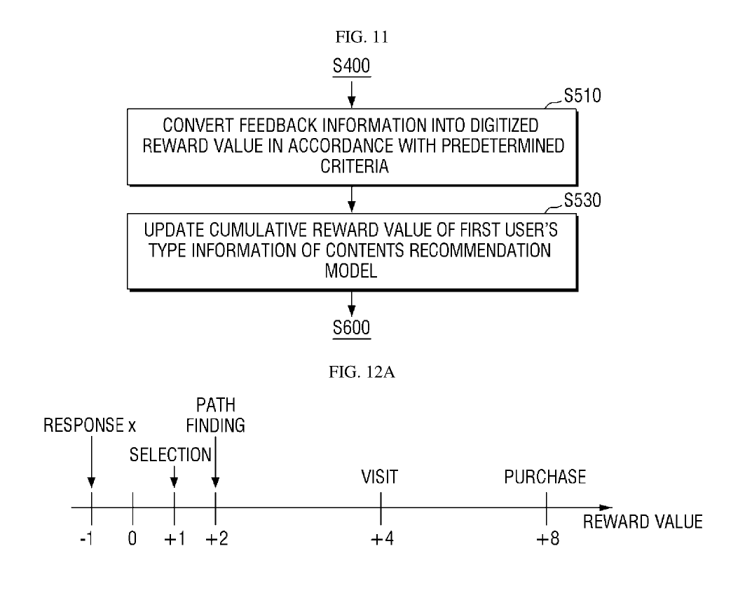

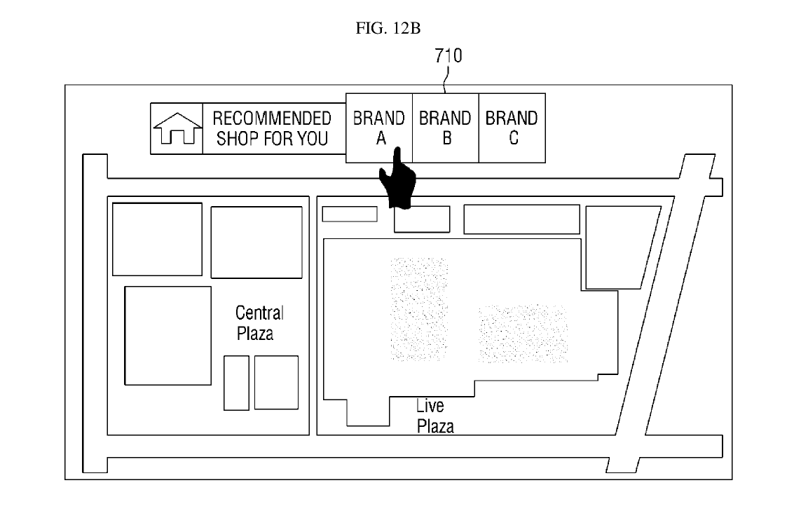

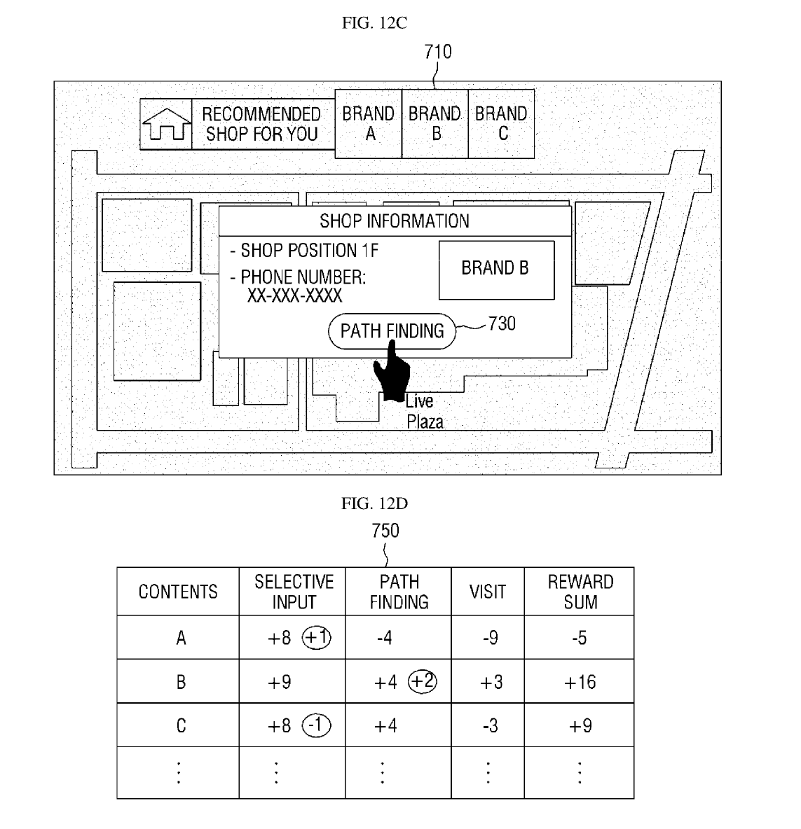

Next, the contents recommendation terminal 300 transmits the acquired user's feedback information to the contents recommendation server 100 (S160). Upon receiving the user's feedback information, the contents recommendation server 100 changes the feedback information of the user to a digitized reward value and reflects the reward value on the contents recommendation model (S180). The step (S800) of reflecting the feedback information will be described later with reference to FIGS. 11 to 12.

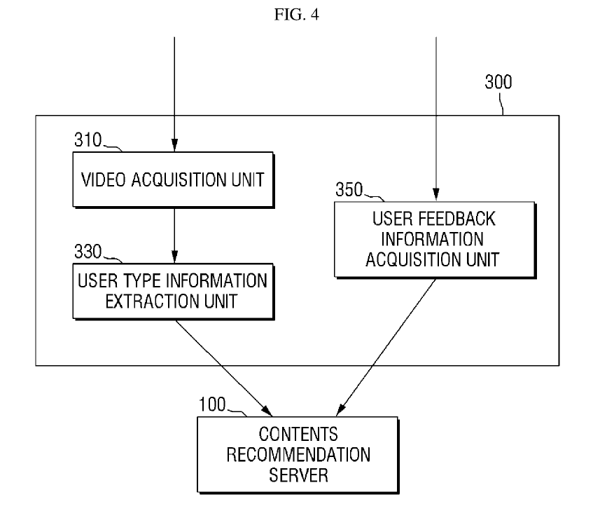

The flow of operations executed between the contents recommendation system 10 according to one exemplary embodiment and the constituent elements constituting the contents recommendation system has been described. Hereinafter, the contents recommendation terminal 300 and the contents recommendation server 100 which are constituent elements of the contents recommendation system 10 will be described in detail with reference to FIGS. 4 to 6.

FIG. 4 is a functional block diagram of the contents recommendation terminal 300 which is a constituent element of the contents recommendation system 10.

Referring to FIG. 4, the contents recommendation terminal 300 may include a video acquisition unit 310, a user type information extraction unit 330, and a user feedback information acquisition unit 350. However, FIG. 4 illustrates only the constituent elements associated with the exemplary embodiment. Therefore, one of ordinary skill in the art to which the present exemplary embodiment pertains may understand that other general-purpose constituent elements may be further included in addition to the constituent elements illustrated in FIG. 4. For example, the contents recommendation terminal 300 may include a communication unit that performs data communication with the contents recommendation server 100, a display unit that displays information to the user, an input unit that receives the input of user's feedback information, a control unit that controls the overall operations of the control unit 300 of each contents recommendation terminal, and the like.

Looking over each function block, the video acquisition unit 310 acquires data such as video and still image, as raw data for extracting type information of the user. As described above, the video acquisition unit 310 may acquire video obtained by capturing the user using a camera equipped in the contents recommendation terminal 300, and may acquire video in the way of receiving the video captured by another data collection device depending on the implementation method.

The user type information extraction unit 330 analyzes the video acquired by the video acquisition unit 310 to extract the type information of the user. The type information of the user may include demographic information such as gender and age, and user's situation information as described above. In order to extract the user's demographic information from the acquired video, the user type information extraction unit 330 may analyze the video, by applying at least one or more computer vision algorithms well-known in the art. In addition, the user type information extraction unit 330 may use the image recognition technique well-known in the art to extract the situation information of the user from the video. For example, the user type information extraction unit 330 may extract a keyword representing the user's situation from the video acquired using a deep learning-based image recognition technique such as Clarifai, as situation information of the user.

In this way, the user type information extraction unit 330 may minimize the intervention of the user in the process of acquiring the type information of the user, by automatically extracting the user's demographic information and the situation information via the video analytics.

The user feedback information acquisition unit 350 acquires various kinds of feedback information of the user exposed to the recommended contents. The user feedback information acquisition unit 350 acquires the reaction of the user that can be detected using various input functions of the contents recommendation terminal 300 as feedback information. As described above, the feedback information may include various kinds of information including an affirmative or negative response of the user to the contents recommendation. For example, the time at which the user looks at the recommended content, a touch input or a click input of the recommended contents and the like may be feedback information of the user.

The contents recommendation terminal 300 may interoperate so that the contents recommendation server 100 can reflect the preference of the user in real time by transmitting the feedback information of the user acquired by the user feedback information acquisition unit to the contents recommendation server 100.

Each of the constituent elements of FIG. 4 described above may mean software or hardware such as FPGA (Field Programmable Gate Array) or ASIC (Application-Specific Integrated Circuit). However, the above-described constituent elements are not limited to software or hardware, but may be configured to be located in a storage medium capable of addressing, and may be configured to execute one or more processors. The functions provided in the above-mentioned constituent elements may be achieved by the further subdivided constituent elements, and may be achieved by a single constituent element that performs a specific function by adding a plurality of constituent elements.

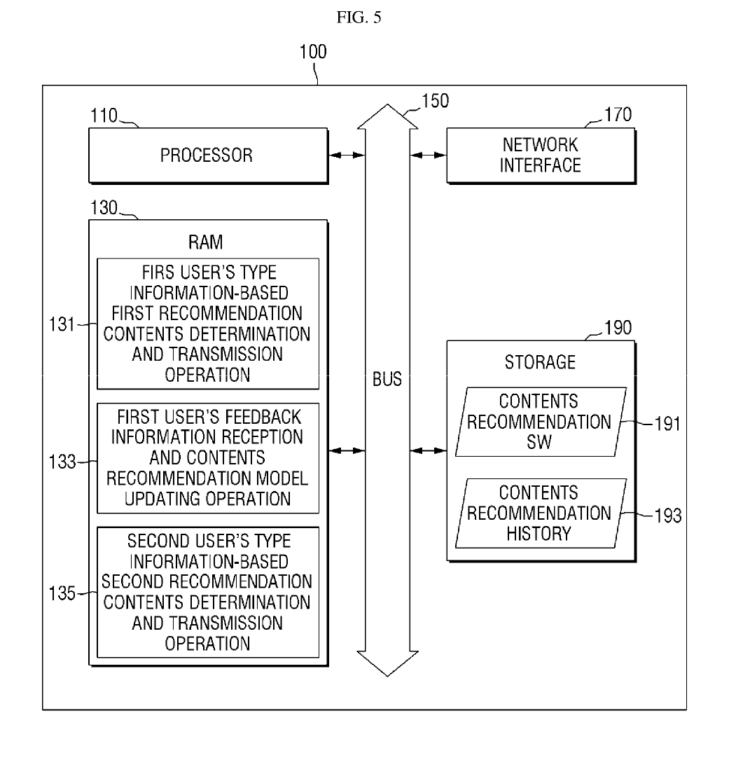

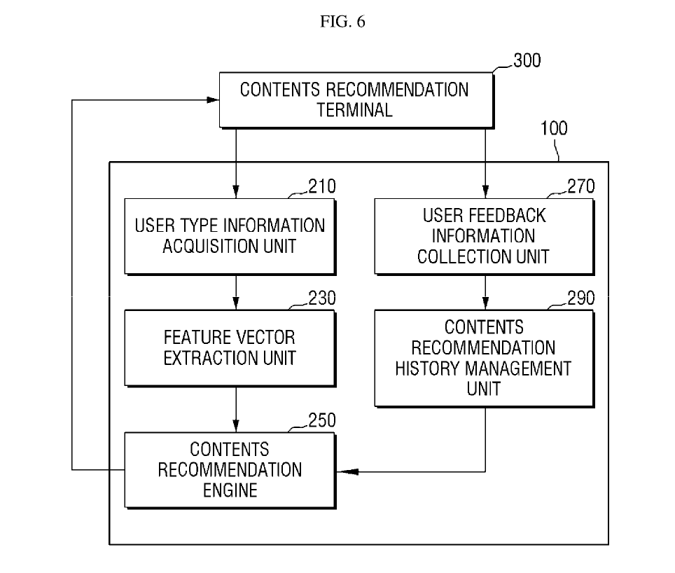

Next, with reference to FIGS. 5 to 6, a detailed hardware configuration and functional blocks of the contents recommendation server 100 according to another exemplary embodiment will be described.

First, referring to FIG. 5, the contents recommendation server 100 according to the present exemplary embodiment includes one or more processors 110, a network interface 170, a memory 130 which loads a computer program executed by the processor 110, and a storage 190 which stores the information software 191 and the contents recommendation history 193. However, FIG. 5 illustrates only the constituent elements associated with the exemplary embodiment. Therefore, one of ordinary skill in the art to which the present exemplary embodiment belongs may understand that other general-purpose constituent elements may be further included in addition to the constituent elements illustrated in FIG. 5.

Here, the contents recommendation history 195 means a past history including recommended contents for each user type determined by the contents recommendation server 100 so far and the feedback information associated therewith, unlike the reward value of the contents for each user type learned in real time by the contents recommendation model.

Looking over each constituent element, the processor 110 controls the overall operations of each configuration of the contents recommendation server 100. The processor 110 may be configured to include a CPU (Central Processing Unit), a MPU (Micro Processor Unit), a MCU (Micro Controller Unit), or any type of processor well-known in the art of the present disclosure. Also, the processor 110 may perform operations of at least one application or program for executing the method according to the exemplary embodiments.

The memory 130 stores various data, commands and/or information. The memory 130 may load one or more programs 191 from the storage 190 to execute the contents recommendation method according to the exemplary embodiment. In FIG. 5, an RAM is illustrated as an example of the memory 130.

The bus 150 provides a communication function between the constituent elements of the contents recommendation server 100. The bus 150 may be provided as various forms of buses such as an address bus, a data bus, and a control bus.

The network interface 170 supports wired or wireless communication of the contents recommendation server 100. To this end, the network interface 170 may be configured to include a communication module well-known in the technical field of the present disclosure.

The network interface 170 may exchange data with one or more contents recommendation terminals 300 via a network. Specifically, the network interface 170 may receive the recommendation request message, the type information of the user, the feedback information of the user and the like from the contents recommendation terminal 300, and may transmit the recommended contents, the confirmation message (ACK) or the like to the contents recommendation terminal 300. Further, the network interface 170 may receive feedback information of the user from another data analysis device.

The storage 190 may non-temporarily store one or more programs 191 and the contents recommendation history 193. In FIG. 5, the contents recommendation software 191 is illustrated as an example of one or more programs 191.

The storage 190 may be configured to include a nonvolatile memory such as a ROM (Read Only Memory), an EPROM (Erasable Programmable ROM), an EEPROM (Electrically Erasable Programmable ROM), and a flash memory, a hard disk, a removable disk, or a computer-readable recording medium of any form well-known in the art.

The contents recommendation software 191 is loaded into the memory 130, and is executed by one or more processors 110. The computer program includes an operation 131 which inputs the first type information of the user acquired at the first time to the contents recommendation model and transmits the determined first recommendation contents to the contents recommendation terminal, an operation 133 which receives the feedback information of the first user exposed to the first recommendation contents from the contents recommendation terminal and updates the contents recommendation model by reflecting the feedback information on the contents recommendation model, and an operation 1353 which inputs the second type information of the second user acquired at the second time after the first time to the updated contents recommendation model and transmits the determined second recommendation contents to the contents recommendation terminal. However, the first type information includes the situation information at the first time point, the second type information includes the situation information at the second time point, the first type information and the second type information indicate the same value, and the first recommendation contents and the second recommendation contents may be different contents from each other.

This means that other contents may be recommended to information of the same user's type with the elapse of time, by reflecting the feedback information of the first user to update the contents recommendation model through the contents recommendation server.

Next, FIG. 6 is a functional block diagram of a contents recommendation server 100 according to another exemplary embodiment.

Referring to FIG. 6, the contents recommendation server 100 includes a user type information acquisition unit 210, a feature vector extraction unit 230, a contents recommendation engine 250, a user feedback information collection unit 270, and a contents recommendation history management unit 290. However, FIG. 6 illustrates only the constituent elements associated with the exemplary embodiment. Therefore, one of ordinary skill in the art to which the present disclosure belongs may understand that other general-purpose constituent elements may be further included in addition to the constituent elements illustrated in FIG. 6. For example, the contents recommendation server 100 may further include a communication unit that performs data communication with the contents recommendation terminal 300, a control unit that controls the overall operation of the contents recommendation server 100, and the like.

Looking over each function block, the user type information acquisition unit 210 may acquire the type information of the user who requested the contents recommendation from one or more contents recommendation terminals 300. In addition, the user type information acquisition unit 210 may collect situation information of the location where the contents recommendation system 10 is installed from another data analysis device, or may further acquire situation information such as weather and time from an internal or external data source.

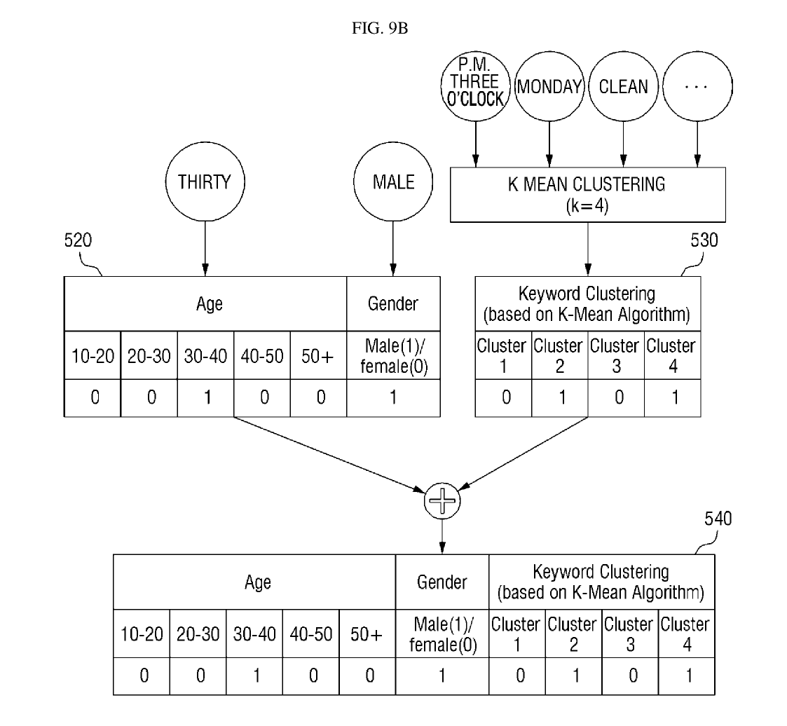

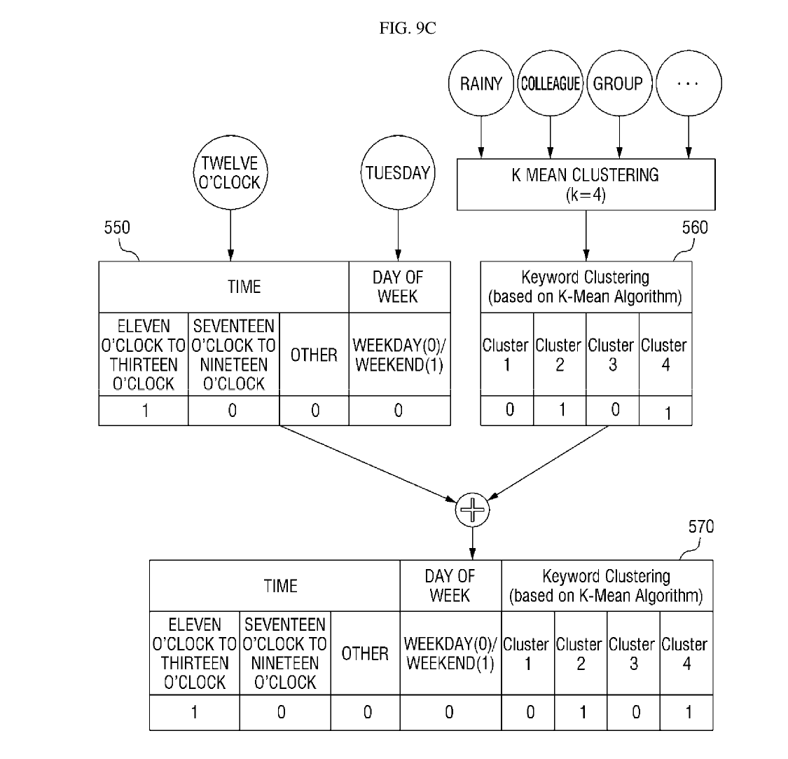

The feature vector extraction unit 230 may extract the feature vector which is an input of the contents recommendation engine 250 from the user type information acquired by the user type information acquisition unit 210. The feature vector is a vector having digitized feature values of the user's type. A method for extracting the feature vector will be described later with reference to FIG. 9.

The contents recommendation engine 250 determines the recommended contents using the MAB algorithm on the basis of the reward value of the recommendation candidate data matching the feature vector. The recommended contents may vary depending on the type of MAB algorithm to be used, and the contents recommendation engine 250 may be provided using the MAB algorithms widely known in the art, or may be provided using combinations of one or more MAB algorithms.

The contents recommendation engine 250 may reflect the preferences of the user in real time on the basis of the feedback information of the user, and may change the recommended contents that are recommended for the user. More specifically, the contents recommendation engine 250 may perform learning, by converting the collected feedback information of the user into a digitized reward value, and reflecting the reward value on the reward values of the contents for each user. Since the recommended contents determined by the MAB algorithm may also vary with the change in the reward values of the contents for each user, the contents recommendation engine 250 may perform the contents recommendation reflecting the preference of the user variable depending on the time.

The user feedback information collection unit 270 collects various kinds of user feedback information from the contents recommendation terminal 300 or another data analysis device. The collected feedback information is input to the contents recommendation engine 250 again, and may be used to more accurately determine the recommended contents having high preference when performing the preference of the same user's type at a later time.

Finally, the contents recommendation history management unit 250 manages the contents recommendation history which is past data of the contents recommendation. The contents recommendation history management unit 250 may use the DB-converted storage device to manage the contents recommendation history. The contents recommendation history may include a feature vector indicating the user's type who requested the contents recommendation, recommended information and feedback information of the user associated therewith.

Each of the constituent elements of FIG. 6 described above may mean software or hardware such as FPGA (Field Programmable Gate Array) or ASIC (Application-Specific Integrated Circuit). However, the above-described constituent elements are not limited to software or hardware, but may be configured to be located in a storage medium capable of addressing, and may be configured to execute one or more processors. The functions provided in the above-mentioned constituent elements may be achieved by the further subdivided constituent elements, and may be achieved by one constituent element that performs a specific function by combining the plurality of constituent elements.

The contents recommendation server 100 according to the present exemplary embodiment has been described above with reference to FIGS. 5 and 6. Next, a contents recommendation method executed by the contents recommendation server will be described in detail with reference to FIG. 7.

FIG. 7 is a flowchart of a contents recommendation method according to another exemplary embodiment. Hereinafter, for convenience of understanding, it is noted that the description of the subject of each operation included in the contents recommendation method may be omitted.

Referring to FIG. 7, when the first user requests the contents recommendation via the contents recommendation terminal 300 at an arbitrary first time point, the contents recommendation server 100 receives the type information of the first user from the contents recommendation terminal 300 (S200). As described above, the type information of the first user may include demographic information and situation information at the first time point, and may be information derived by the performing the video analytics through the contents recommendation terminal 300. However, the contents recommendation server 100 may further acquire situation information such as time, day of the week and weather from the internal or external data source.

Upon receiving the type information of the first user, the contents recommendation server 100 inputs the type information of the first user into the contents recommendation model to determine the first recommendation contents (S300). As described above, the contents recommendation model is a model which inputs the user's type information and outputs the recommended content, and determines the recommended contents, using the MAB algorithm, on the basis of the reward values of the contents of each user's type.

Next, the contents recommendation server 100 transmits the determined first recommendation contents to the contents recommendation terminal 300, and receives feedback information of the first user from the contents recommendation terminal (S400). However, the feedback information may be obtained from another data analysis device, in addition to the contents recommendation terminal. For example, whether the first user visits the shop or the like may be feedback information derived by analyzing the movement route of the first user through the data analysis device.

The contents recommendation server 100 updates the contents recommendation model, by reflecting the feedback information of the first user back to the contents recommendation model again (S500). Specifically, the contents recommendation server 100 updates the reward value of the contents of the first user's type included in the contents recommendation model, the recommended contents that are output by the MAB algorithm may be changed with the update of the reward value.

Next, the contents recommendation server 100 receives the type information of a second user having the same type information as the first user at the second time point after the first time point (S600). The second user may be a user different from the first user, but the second user may be the same user as the second user in terms of the demographic information and situation information. For example, the first user and the second user may be a male in his twenties having the same age as gender, and may be users who visit a compound shopping mall in the similar time zone of the same day.

The contents recommendation server 100 determines the second recommendation contents, which are the recommended contents for the second user, with the reception of the type information of the second user (S700). Here, the second content may include contents at least partly different from the first contents. The reason is that the reward values of the contents recommendation model are updated according to the feedback of the first user, and the recommended contents can be changed accordingly.

The contents recommendation method according to the present exemplary embodiment has been described above with reference to FIG. 7. According to the method, the contents recommendation server 100 can recommend the customized contents flexibly and accurately as compared to the fixed rule-based recommendation method, by reflecting the preference that varies in accordance with the flow of time for each user's type on the basis of the feedback of the user.

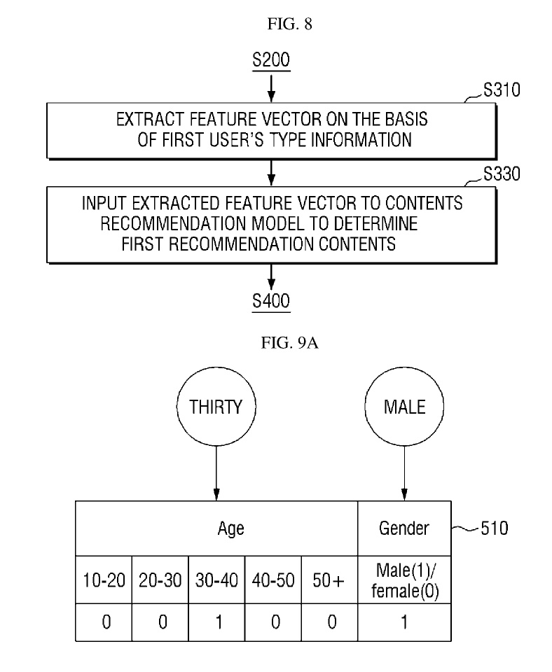

Next, with reference to FIG. 8, the first content determination step S300 illustrated in FIG. 7 will be described in detail referring to FIG. 8.

Referring to FIG. 8, the contents recommendation server 100 extracts the feature vectors on the basis of the type information of the first user (S310). The above feature vector is a value obtained by converting the type information of the user into a digitized form and may be the value used for the actual input of the contents recommendation model.

For convenience of understanding, the step (S310) of extracting the feature vector will be described, for example, with reference to FIGS. 9A to 9C.

First, referring to FIG. 9A, the feature vector 510 may have a plurality of attribute fields and values of each attribute. In the case of the feature vector 510 illustrated in FIG. 9A, it is possible to know that the age and the gender are included as the attribute field, and the age attribute field has five sub-attribute fields again for each age group. Further, it is possible to know that 0 or 1 is defined for each attribute field. However, the feature vector 510 illustrated in FIG. 9A is merely an example for explaining a feature vector, and the number, type and format of attribute fields included in the feature vector may vary as much as depending on the implementation method.

The contents recommendation server 100 may extract the digitized feature vector by converting each of type information of the user into the values of the corresponding attribute fields. For example, if the type information on the acquired user is ‘thirty’ and ‘male’, the contents recommendation server 100 may set the values of the ‘30 to 40’ attribute fields corresponding to ‘thirty’ to ‘1’, and may set the value of the ‘gender’ field corresponding to ‘male’ to ‘1’.

On the other hand, the type information of the user used by the contents recommendation server 100 includes various kinds of situation information in addition to the demographic information. However, since the number of extracted situation information is variable and very various kinds of information may be extracted, it is inefficient to give attribute fields of feature vectors for each kind of situation information. Also, the user's type may be excessively subdivided due to the situation information. Therefore, the contents recommendation server 100 clusters the situation information so as to be mapped to the predetermined number of clusters, so that only a fixed number of attribute fields is assigned to the situation information, regardless of the number of situation information.

Referring to the example illustrated in FIG. 9B, the contents recommendation server 100 may extract the first feature vector 520 on the basis of the demographic information included in type information of the user. For example, when the above demographic information is ‘thirty’, and ‘male’, the contents recommendation server 100 may extract the first feature vector 520.

Next, in the case of the situation information included in the type information of the user, the contents recommendation server 100 may extract the second feature vector 530 on the basis of the clustering result. The clustering may be performed, using a clustering algorithm well-known in the art. For example, the K-average clustering algorithm may be used as illustrated in FIG. 9B. The case of FIG. 9B illustrates an example in which only the four attribute fields are allocated to the feature vector, regardless of the number of situation information, by using the K-average algorithm in which K is ‘4’. Since the K-average clustering algorithm is an algorithm well-known in the art, the description thereof will not be provided.

The contents recommendation server 100 may extract the second feature vector by checking the cluster in which the acquired user's situation information is located among the clusters that have already been constructed. For example, the second feature vector 530 illustrated in FIG. 9B illustrates a feature vector 530 extracted when located in the second and fourth clusters, among four constructed clusters such as ‘3 p.m.’, ‘Monday’, and ‘sunny’, which are keywords indicating the situation information.

For reference, when the contents recommendation terminal 300 is implemented to extract the keyword indicating the situation information using Clarifi, the contents recommendation server 100 may construct the cluster in advance using the keyword set that can be provided as the analysis result by Clarifi, and the value of K that indicates the number of clusters of the K-average clustering algorithm may differ depending on the implementation method.

The contents recommendation server 100 may combine the first feature vector 520 and the second feature vector 530 to finally extract the feature vector 540 indicating the user's type.

Next, FIG. 9C illustrates another example in which the contents recommendation server 100 extracts the feature vector. In the case of FIG. 9B, the contents recommendation server 100 calculates the clustering result for the entire situation information. However, depending on the implementation method, the contents recommendation server 100 may calculate the clustering result only for the first situation information which is some situation information included in the situation information of the user. This is because the second situation information which is included in the situation information of the user and is not the first situation information may be an important criterion for determining the recommended contents.

For example, assuming that there are a large number of companies around the complex shopping mall, there is a statistically high possibility that the users visiting the compound shopping mall during weekday lunch or evening hours visit restaurants located in the complex shopping mall, rather than the shopping purposes. Therefore, since information on the day of the week and information on the time in the situation information may become an important criterion by which the type of the contents may vary, the information may be implemented to have an independent attribute field in the feature vector.

Referring to FIG. 9C, as in the above example, it is possible to check that ‘noon’ and ‘Tuesday’ which are information on the time and the day of week in the situation information are converted into the value of the independent attribute field of the feature vector 550, and the situation information such as ‘rain’, ‘collage’, and ‘group’ are extracted as attribute values of feature vectors through clustering.

For reference, the examples illustrated in FIGS. 9B and 9C illustrate only the example in which the situation information among the type information of the user becomes a target of clustering, but the demographic information may also become an attribute that is converted into a feature vector through clustering, rather than becoming an independent attribute field of the feature vector, which is only a difference in implementation method.

An example in which the contents recommendation server 100 extracts the feature vector has been described with reference to FIGS. 9A to 9C.

Returning to FIG. 8 again, the contents recommendation server 100 inputs the extracted feature vector to the contents recommendation model to determine the first recommendation contents (S330). Specifically, the first contents may be determined by executing the MAB algorithm on the contents recommendation model on the basis of the reward values of each of contents corresponding to the feature vector.

Referring to FIG. 10, in more detail, the contents recommendation model may include the reward value of each of contents for each user's type as illustrated in FIG. 10. The reward values of the contents may be set for each user's type indicated by the feature vector, and the reward values of each content may be understood as the data in which feedback of the user is learned. In other words, the reward values of each content may be understood as the values reflecting the preference in which the user of the type indicated by the feature vector has for each content.

For example, the table 620 may indicate the preference of male users of teenagers having a feature vector 610 of ‘100001’ for each content, and the table 630 may indicate preference of male users in their twenties having a feature vector 610 of ‘010001’ for each content.

Looking over table 620, the values of each feedback type mean the reward value accumulated for each feedback type, and the compensation sum means the value obtained by adding the accumulated reward values of each feedback type. The table 620 illustrates that the user feedback has been most positive as a result of recommending the contents B to a male user of teenage having the feature vector 610 of ‘100001’, and indicates that the user feedback is the most negative as a result of recommending the contents A as information. For reference, the contents of each table 620, 630 may also include contents that are not determined as the recommended contents, and in the case of contents that are not recommended, the compensation total may be displayed as ‘0’. Also, in the tables 620, 630, the cumulative values of each feedback type are calculated assuming that the reward values for feedback have the same weight according to the time. However, when the latest reward value has the larger weight, the cumulative values of each feedback type may also be calculated by accumulating the values after multiplying the past reward values by a discount rate having a value between 0 and 1.

The contents recommendation model may operate to output the recommended contents, by performing the MAB algorithm based on the reward values illustrated in the table 620, 630 when a feature vector enters the input. For example, when the extracted feature vector is ‘100001’, the contents recommendation model executes the MAB algorithm on each of contents A, B, C of the table 620 to output the recommended contents.

The consequentially output contents may vary depending on the MAB algorithm. For example, in case of using the Epsilon-Greedy algorithm, the empirically best responsive contents based on the reward values of each content by the probability of epsilon are determined as the recommended contents (Exploitation mode), and other contents other than the best responsive contents by probability of 1-epsilon may be determined as the recommended contents (Exploration mode). The empirically best responsive contents may be, for example, a content B having the highest compensation sum, and the top N contents having the highest compensation sum when recommending the N contents may be determined as the recommended contents.

As another example, in the case of using the UCB, if there are contents that have never been recommended, the contents are first recommended, and if there are no content that have never been recommended, the UCB is calculated for each content on the basis of the reward value and the recommended number of times, and the values of the high UCB may be determined as the recommended contents.

In addition, various algorithms widely known in the technical field may be used, and the recommended contents may be determined through a combination of one or more algorithms, which is merely a difference in implementation methods.

Until now, a method has been described in which the contents recommendation server 100 extracts a feature vector and determines the recommended contents, using a contents recommendation model in which the feature vector is input. According to the above-described method, the contents recommendation server 100 may determines the recommended contents in consideration of the preference that is variable according to the time, by determining the recommended contents, using the MAB algorithm, on the basis of the reward values of each content learned through the feedback of the user.

Next, a method for reflecting the user's feedback information by the contents recommendation server 100 and an example of giving differentiated reward values for each type of feedback will be described with reference to FIGS. 11 to 12.

First, referring to FIG. 11, the contents recommendation server 100 converts the feedback information collected from the contents recommendation terminal 300 or another data analysis device into a digitized reward value, in accordance with a predetermined criterion (S510). Here, the digitized reward value may be different reward values for each type of feedback information. This is to give the greater reward value to the feedback on which the user's preference is reflected and to perform a more accurate recommendation.

For example, when recommending brands of stores that have entered the complex shopping mall through the digital signage, the user's feedback information such as the selective input for the recommended shop brand, the path finding request for the recommended shop, visiting for the recommendation shop, and the product purchase in the recommended shop, may be variously set. Among them, the selective input of the shop brand may be a selection based on curiosity rather than the intention of the user who tries to visit the shop. In fact, the selection based on the curiosity may be only noise information that is unnecessary for determining the preference for each of the user types. Therefore, by giving a relatively large reward value to the feedback information in which the user's preference intention is strongly reflected, and by giving a comparatively small reward value to the feedback information in which the user's preference intention is weakly reflect, it is possible to minimize the influence of noise information and to improve the recommendation accuracy.

Next, the contents recommendation server 100 updates the reward values for each user's type learned through the contents recommendation model (S530). For example, when the feedback information is the feedback information on the first user type, among the reward values for each user's type learned through the contents recommendation model, the reward value can be updated in the way of accumulating the reward value of the type of the first user. Further, as described above, the reward value may be updated in the way of by multiplying the past reward values by a predetermined discount rate and then accumulating the values.

In order to provide convenience of understanding, when recommending a brand that entered a compound shopping mall referring to FIGS. 12A to 12D, an example of giving the differentiated reward values in accordance with the feedback information, and updating the reward value will be briefly described.

FIG. 12A illustrates an example of giving the differentiated reward value in accordance with the type of feedback information. Referring to FIG. 12A, the contents recommendation server 100 may give ‘−1’ point to the recommended brand that has no response from user, ‘+1’ point when the user selects the recommended brand, +4’ points when the user visits the shop of the brand, and ‘+8’ point when the user purchases a specific item at the visited shop. This is because the consumer's preference intention is more strongly given toward the right side of the arrow illustrated in FIG. 12A.

For reference, the feedback information on whether or not the user has visited the shop may be extracted, by tracking the movement route of the user through the collected video by another data analysis device, or by analyzing the WIFI data to track the movement route of the terminal of the user. Also, feedback information on whether or not a specific item was purchased may be extracted by capturing the video near the register of the shop by another data collection device, and by analysing the time at which the user stays near the cash register, the user's staring target near the cash register, the starting time or the like through another data analysis device.

FIG. 12B illustrates the user's feedback that makes a selective input (710) of the recommended brand A, and FIG. 12C illustrates the user's feedback that makes the path (e.g., direction) finding request (730) of the recommended brand B. FIG. 12D also illustrates an example of updating the reward value when the feedback information of the user illustrated in FIGS. 12B and 12C is acquired.

A table 750 illustrated in FIG. 12D is the reward value data of the user's type who gives the feedback, among the reward value data of the type-specific contents of the user learned by the contents recommendation model. When acquiring the feedback information of the selective input 710 on the recommended brand information A, after the contents recommendation server 100 converts the feedback information of the selective input into the digitized reward value (+1), the contents recommendation model can be updated by adding the reward value (+1) to the reward value of the brand A. Also, when acquiring the feedback information of the path finding request 730 of the recommended brand information B, after the contents recommendation server 100 converts the feedback information of the path finding request into the digitized reward value (+2), the reward value can be updated by adding the converted reward value (+2) to the reward value for the brand B. Further, in the case of the brand information C for which the feedback information is not acquired, the contents recommendation server 100 may update the reward value by adding the reward value (−1) in which there is no response. In this way, by adding the reward values of the respective information based on the differentiated reward values, the contents recommendation server 100 reflects the user's type-specific preference in real time and may perform more accurate recommendation.

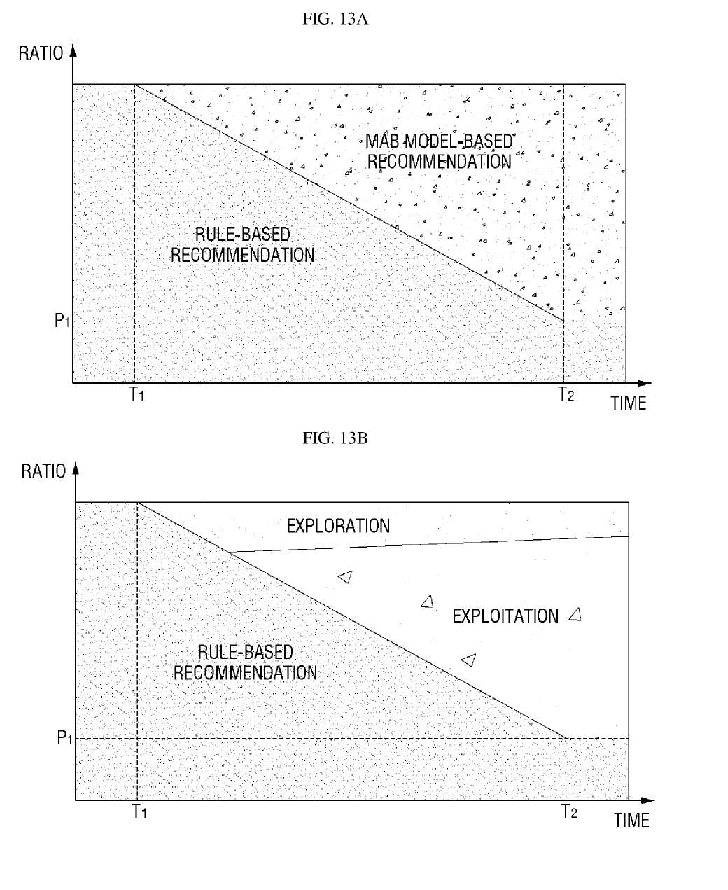

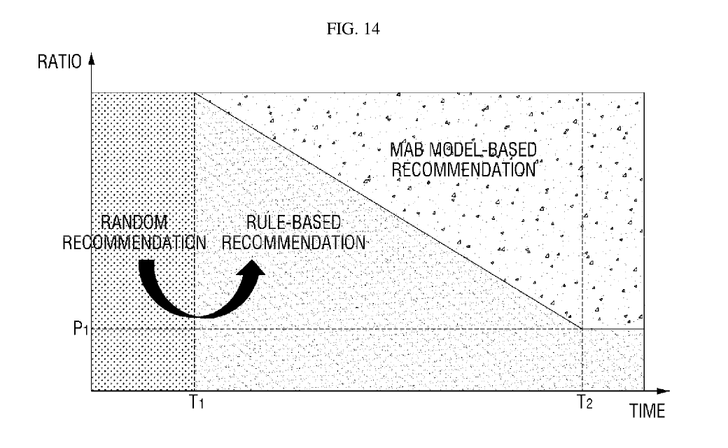

Until now, a method for reflecting the user's feedback information by the contents recommendation server 100, and an example of giving the differentiated reward values for each type of feedback have been described. Next, with reference to FIGS. 13 to 14, an embodiment will be described in which the contents recommendation server 100 determines the recommended contents by utilizing a plurality of recommendation policies.

As described above, the contents recommendation server 100 may determine the recommended contents, using the contents recommendation model (hereinafter, ‘MAB model’) that operates on the basis of the MAB algorithm. Since the MAB algorithm is an algorithm in the field of reinforcement learning technique, when the feedback information of the user is not sufficient, accuracy of contents recommendation may be lowered. In other words, at the initial stage of constructing the contents recommendation system 10, since the feedback information of the user is insufficient, there may be a problem in which accurate recommendation may not be performed. In order to solve such a problem, the contents recommendation server 100 may simultaneously operate a rule-based recommendation policy defined on the basis of prior information and a MAB model-based recommendation policy to perform the contents recommendation.

FIG. 13A illustrates an example in which the contents recommendation server operates on the basis of the rule-based first recommendation policy and the MAB model-based second recommendation policy when a rule for contents recommendation is given. In FIG. 13B, an X axis illustrates the flow of time, and a Y axis illustrates an occupancy ratio of each recommendation policy.

First, looking over the characteristics of the rules and the MAB model used for each recommendation policy, the rule used in the first recommendation policy may be a rule defined on the basis of the prior information on the preference for each user's type. For example, when recommending a brand that entered a complex shopping mall, the rule may be defined on the basis of the preference brand information for each user's type provided by a marketer. In addition, the rule may be defined manually at the initial stage of the system, and may be a rule which generally distinguishes the user's type only on the basis of the gender and age and determines the recommended brand accordingly.

On the other hand, since the MAB model used for the second recommendation policy distinguishes the user's type including the situation information, it is possible to determine the recommended contents for the subdivided user's type. Also, since it is possible to reflect the user's preference in real time on the basis of the user's feedback, it is possible to recommend other contents for the same user's type according to time.

Referring to FIG. 13A, the contents recommendation server 100 may recommend information using only the first recommendation policy until the first time point T1. Also, when the first time point T1 elapses, the contents recommendation server 100 uses the second recommendation policy, and until reaching the second time point T2, the contents recommendation server 100 may gradually increase the occupancy ratio of the second recommendation policy. This is because the accuracy of recommendation of the second recommendation policy can be improved, as the reward values of the contents for each type of each user, which are the learning data reflecting the user's feedback, are gradually accumulated.

After the first time point T1, the contents recommendation server 100 determines one of the recommendation policies on the basis of the occupancy ratio of each recommendation policy among the first recommendation policy and the second recommendation policy, and may determine the recommendation content on the basis of the determined recommendation policy. The occupancy ratio of the recommendation policy means a ratio at which each recommendation policy is used in accordance with the contents recommendation request. It can be seen in the graph illustrated in FIG. 13A that the occupancy ratio of the first recommendation policy using the rule is 100% at the first time point T1, and thereafter gradually decreases.

The contents recommendation server 100 may reduce the occupancy ratio of the first recommendation policy and increase the occupancy ratio of the second recommendation policy with the passage of time. That is to say, the contents recommendation server 100 may adjust the occupancy ratio of each recommendation policy in the way of reducing the occupancy ratio of the first recommendation policy and increasing the occupancy ratio of the second recommendation policy by reflecting the degree of learning of the MAB model used for the second recommendation policy, and the total occupancy ratio of each recommendation policy may be constant.

Specifically, the contents recommendation server 100 may adjust the occupancy ratios of the first recommendation policy and the second recommendation policy on the basis of the number of feedback information. The contents recommendation server 100 calculates the number of feedback information accumulated for each user's type, and may adjust the occupancy ratio of the first recommendation policy and the second recommendation policy, on the basis of at least one value of the average and the variance of the number of the feedback information for each user's type. In other words, as the average value of the number of feedbacks for each user's type increases or the variance value of the number of feedbacks for each user's type decreases, the contents recommendation server 100 may decrease the occupancy ratio of the first recommendation policy and may increase the occupancy ratio of the second recommendation policy. The reason is that, as the average value of the feedback number for each user's type gets larger, large feedback is obtained, and as the variance value of the feedback number for each user's type gets smaller, the feedback information is evenly collected for each user's type.

However, after the second time point T2 at which the occupancy ratio of the second recommendation policy has reached a predetermined upper limit value (100-P1), even if the average value of the feedback number increases or the variance value of the feedback number decreases, the contents recommendation server 100 may maintain the occupancy ratio of the second recommendation policy without further increasing the occupancy ratio. That is to say, after the occupancy ratio of the first recommendation policy reaches the predetermined lower limit value P1, even if the average value of the feedback number increases or the variance value of the feedback number decreases, it is possible to maintain the occupancy ratio of the policy without further decreasing the occupancy ratio. This is because, the second recommendation policy is a recommendation policy reflecting the user's preference in real time, and there is a possibility that the user's preference gradually changing according to the time may be eliminated. Therefore, the contents recommendation server 100 may maintain the occupancy ratio of the first recommendation policy at a predetermined value P1 or higher in order to consider both the real-time changing preference and the gently changing preference.

Depending on the implementation method, the contents recommendation server 100 may recommend the contents determined using the MAB model-based second recommendation policy and the contents determined using the predetermined rule-based first recommendation policy to the user together at a predetermined ratio. In such a case, the Y axis of the graph illustrated in FIG. 13A may be the ratio of the number of contents determined based on the first recommendation policy to the number of contents determined based on the second recommendation policy. For example, assuming that the ratio of the first recommendation policy is 80%, the ratio of the second recommendation policy is 20%, and ten contents are recommended to the user, the contents recommendation server 100 may select eight contents on the basis of the first recommendation policy and select the two contents on the basis of the second recommendation policy, thereby determining the ten contents. In addition, as the feedback information is collected, the contents recommendation server 100 may operate in the way of increasing the number of contents determined based on the second recommendation policy, and decreasing the number of contents determined based on the first recommendation policy.

Meanwhile, the contents recommendation server 100 may generate a rule on the basis of the reward values of the contents for each user's type of the MAB model in non-real time for each predetermined time, and may update the rule of the first recommendation policy on the basis of the generated rule. This is to prevent the rule of the first recommendation policy from greatly differing from the preference of the user. For example, the contents recommendation server 100 generates a rule for determining the top N contents with high reward value for each user's type as the recommended content, and may update the rule used in the first policy on the basis of the generated rule. Also, the contents recommendation server 100 may operate the plurality recommendation policies in the way of initializing the occupancy ratio of each recommendation policy as in the first time point T1, while updating the rule of the first recommendation policy as described above, and updating only the second recommendation policy in real time again, depending on the implementation method.

For reference, the rules generated by the contents recommendation server 100 may be a rule for determining the recommended contents on the basis of the user's type which is further subdivided than the rules provided by the marketer. For example, the rules provided by the marketer may distinguish the types of users only on the basis of the age and gender, but the rules generated by the contents recommendation server 100 may distinguish the user's type by further considering situation information such as the day of the week and weather, in addition to the demographic information such as age and gender. This is because the rules provided by marketers only consider the user's general preference on the market, and there is a limit to considering the user's situation information. On the other hand, since the contents recommendation server 100 subdivides the user's type in consideration of the situation information and collects the feedback on the basis of the user's type, the rule generated by the contents recommendation server may be the rule for performing more accurate recommendation on the basis of the type of subdivided user.

Next, FIG. 13B illustrates two ways in which the MAB model operates on the graph illustrated in FIG. 13A. As mentioned above, the MAB model may operate in two modes of exploration and exploitation. For example, the exploration mode is an operation way of experimentally recommending other contents and collecting various feedbacks without empirically recommending the contents having the highest reward value. Also, the exploitation mode is a way of empirically recommending the contents having the highest reward value. The occupancy ratios of the exploration mode and the exploitation mode depend on the algorithm, and when using the Epsilon-Greedy algorithm, the epsilon is a criterion for determining the exploration and exploitation modes. Generally, as the feedback information is collected, the occupancy ratio of the exploration mode increases and the occupancy ratio of the exploitation mode decreases, and since the exploration and exploitation modes are concepts that are widely known in the field of reinforcement learning, a detailed description thereof will not be provided.

Until now, an example in which the contents recommendation server 100 operates based on a plurality of recommendation policies when rules are given has been described with reference to FIGS. 13A to 13B. Next, an example in which the contents recommendation server 100 operates when no rule is given will be described referring to FIG. 14.

When prior knowledge or rule concerning the contents recommendation is not given, the contents recommendation server 100 randomly recommends the contents up to an arbitrary first time point T1 and may acquire feedback information of the user. Next, the contents recommendation server 100 may automatically generate a rule used for the first recommendation policy on the basis of the accumulated feedback information. That is, the contents recommendation server 100 may generate a rule used for the first recommendation policy, using the reward value of the type-specific content of each user learned on the basis of the feedback information. For example, the contents recommendation server 100 may generate a rule to determine the top N contents having a high reward value for each user's type as the recommended contents.

The contents recommendation server 100 manually searches for the user's preference by automatically generating the rule based on the feedback thus collected, and may reduce the human cost and time consumed for defining the preference as the rule.

Since the operation processes after the first time point T1 is duplicated as description of FIG. 13A, a description thereof will not be provided.

Examples in which recommendation is executed by utilizing multiple recommendation policies have been described with reference to FIGS. 13 to 13. According to the exemplary embodiments described above, when the rule is not given, the contents recommendation server 100 may reduce the management cost by automatically generating the rule through the random recommendation, and when the rule is given, the contents recommendation server 100 may complement the drawbacks of the MAB model that requires learning using the feedback data, using the given rules.

The exemplary embodiments described above with reference to FIGS. 7 to 14 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for recommending contents executed by a contents recommendation server, the method comprising:
determining first recommendation contents based on first type information of a first user acquired at a first time point and a contents recommendation model;
transmitting the first recommendation contents to a contents recommendation terminal and receiving feedback information of the first user exposed to the first recommendation contents from the contents recommendation terminal;
updating the contents recommendation model by applying the feedback information to the contents recommendation model;
determining second recommendation contents based on second type information of a second user acquired at a second time point and the updated contents recommendation model, the second time point being after the first time point; and
transmitting the second recommendation contents to the contents recommendation terminal,
wherein the first type information comprises situation information at the first time point, and the second type information comprises situation information at the second time point,
the first type information and the second type information indicate a same type information, and
the second recommendation contents are different from the first recommendation contents.

2. The method of claim 1, wherein the first type information further comprises demographic information of the first user,
the second type information further comprises demographic information of the second user, and
the first type information and the second type information are information derived through video analytics.

3. The method of claim 2, wherein the demographic information of the first user comprises at least one of a gender and an age of the first user, and
the situation information at the first time point comprises at least one of time, a day of a week, weather, and a type of a group to which the first user belongs.

4. The method of claim 1, wherein the determining first recommendation contents comprising:
extracting a feature vector indicating a type of the first user based on the first type information; and
inputting the feature vector into the contents recommendation model to determine the first recommendation contents,
wherein the contents recommendation model operates based on a multi-armed bandits algorithm (MAB).

5. The method of claim 4, wherein the extracting the feature vector comprises:
extracting a first feature vector based on demographic information included in the first type information;
extracting a second feature vector based on a clustering result of the situation information at the first time point included in the first type information; and
combining the first feature vector with the second feature vector to extract the feature vector indicating the type of the first user.

6. The method of claim 5, wherein the clustering result is generated based on a K-mean clustering algorithm.

7. The method of claim 1, wherein the contents recommendation model is a model which is learned based on a cumulative reward value indicating preference to each content for each user's type, and
the updating the contents recommendation model by applying the feedback information to the contents recommendation model comprises:
converting the feedback information of the first user into a digitized reward value in accordance with a predetermined reference; and
updating a cumulative reward value of first type information of the contents recommendation model based on the digitalized reward value,
wherein the reward value has at least partially different values in accordance with a type of the feedback information.

8. The method of claim 7, wherein the first recommendation contents and the second recommendation contents are brand contents of a shop, and
the feedback information of the first user comprises any one or any combination of information of whether to select the brand contents, information of whether to search for a direction to the shop, information of whether to visit the shop, and information whether to purchase a product at the shop.

9. A method for recommending contents executed by a contents recommendation server, the method comprising:
acquiring type information of a user comprising a situation information of the user;
determining a recommendation policy of a plurality of recommendation policies based on an occupancy ratio of a first recommendation policy to the plurality of recommendation policies, the plurality of recommendation policies comprising the first recommendation policy and a second recommendation policy; and
determining recommendation contents based on the determined recommendation policy,
wherein the first recommendation policy is a policy for determining the recommended contents based on a predetermined rule, and
the second recommendation policy is a policy for determining the recommended contents based on a multi-armed bandits algorithm (MAB) model.

10. The method of claim 9, wherein the predetermined rule is generated based on feedback information collected through random recommendation until a predetermined time point.

11. The method of claim 9, further comprising:
receiving feedback information of the user exposed to the determined recommended contents from a contents recommendation terminal; and
updating the recommendation policy based on the feedback information,
wherein the updating the recommendation policy comprises:
updating the MAB model in real time based on the feedback information; and
updating the predetermined rule used for the first recommendation policy at a predetermined time, based on the MAB model.

12. The method of claim 9, further comprising:
calculating a number of feedbacks applied to the MAB model, and
adjusting the occupancy ratio based on at least one of an average and a variance of the number of feedbacks.

13. The method of claim 12, wherein the adjusting the occupancy ratio comprises:
increasing an occupancy ratio of the second recommendation policy to the plurality of recommendation polices and decreasing the occupancy ratio of the first recommendation policy to the plurality of recommendation policies as the average of the number of the feedbacks increases or the variance of the number of the feedbacks decreases, and
wherein a sum of the occupancy ratio of the first recommendation policy and the occupancy ratio of the second recommendation policy is constant.

14. The method of claim 13, wherein the increasing the occupancy ratio of the second recommendation policy and decreasing the occupancy ratio of the first recommendation policy comprises:
maintaining the occupancy ratio of the first recommendation policy, when the occupancy ratio of the second recommendation policy reaches a predetermined upper limit value, even if the average of the number of feedbacks increases or the variance of the number of feedbacks decreases.

15. A method for recommending contents executed by a contents recommendation server, the method comprising:
collecting feedback information associated with each user type through random recommendation up to a predetermined first time point,
generating a rule for determining recommended contents for each user type based on the collected feedback information; and
determining the recommendation content after the predetermined first time point, based on at least one policy of a first recommendation policy and a second recommendation policy, the first recommendation policy being a policy for determining the recommended contents based on a predetermined rule, and the second recommendation policy being a policy for determining the recommendation contents based a multi-armed bandits algorithm (MAB) model,
wherein an occupancy ratio of a second recommendation policy to a plurality of policies comprising the first recommendation policy and the second recommendation policy at the first time point is less than an occupancy ratio of the second recommendation policy to the plurality of policies at a second time point after the first time point, and
a sum of an occupancy ratio of the first recommendation policy to the plurality of policies and the occupancy ratio of the second recommendation policy is constant.
